(19) United States
(12) Patent Application Publication
(10) Pub. No.: US 2011/0054234 A1
(43) Pub. Date: Mar. 3, 2011

(54) A Method for Storing Hazardous Materials

(76) Inventor: Hans GEORGII, Geneve (CH)

(21) Appl. No.: 12/867,906

(22) PCT Filed: Feb. 17, 2009
(86) PCT No.: PCT/SE09/50164

§ 371 Date: Aug. 17, 2010

(30) Foreign Application Priority Data
Feb. 21, 2008 (SE) 0800401-2

(51) Int. Cl. G21F 9/00

(52) U.S. Cl. 588/17

(57) ABSTRACT

Storage containers (12) holding hazardous material are stacked in a drilled shaft (11) of a diameter slightly larger than the transverse dimension of the storage containers. Initially, a base plug (13) is lowered to the bottom of the shaft (11) and anchored there by means of a setting grouting compound introduced into a clearance space around the base plug. One end of a plurality of cables (15) long enough to extend from the bottom of the shaft to the upper end of the shaft are attached at anchoring points distributed around the periphery of the base plug (13). The storage containers are then successively lowered into the shaft within the space encircled by the cables (15) and stacked in the shaft. The stacking is discontinued well below the upper end of the shaft (11) to provide space for a backfill sealing the shaft.

This invention relates to a method and an installation suitable for the ultimate disposal of spent nuclear fuel removed from nuclear reactors and also for the ultimate disposal of other extremely hazardous materials which cannot be made harmless and must therefore be stored in a manner such that their dangerousness will not entail greater hazards than can be accepted with a very large safety margin.

Today, spent nuclear fuel which is removed from nuclear reactors after it has been burnt up or is removed for other reasons is placed in a submerged position in decay ponds and kept there until its activity and thereby its heat generation has fallen sufficiently. The intention is in due course of time to transfer the spent fuel to an ultimate storage, also known and below referred to as a repository, where it will be safely stored indefinitely.

In fact, there is still no existing real nuclear fuel repository, only temporary arrangements—in most cases decay ponds—for the interim storage, pending the establishment of permanently safe repositories. In the present situation, there are enormous amounts of spent nuclear fuel around the world which, after several decades of interim storage, are still waiting for its ultimate and permanently safe storage.

As things now stand in Sweden, a solution to the problem of safe ultimate disposal of spent nuclear fuel that has been devised but has not yet been implemented, is to deposit the spent nuclear fuel in large casks made of copper—each containing some twenty tons of copper—and embed the casks in clay (bentonite) in the bedrock at a depth on the order of 500 metres. With this contemplated solution, the spent nuclear fuel that is now stored in decay ponds pending its ultimate disposal would alone require an enormous amount of copper. Apart from other problems, the cost of the copper alone would be extremely high.

There are also other proposals for solutions to the ultimate disposal problem which have likewise not been carried into effect. The idea behind some such proposals is to deposit the spent nuclear fuel very deep in vertical bores in the bedrock, the contemplated depths being on the order of several kilometres. It has been held that there is no risk of groundwater moving from the ultimate storage at such depths to the vicinity of the earth's surface. A failure resulting in leakage of radioactive material from the repository would not, therefore, cause any environmental problems near the earth's surface. Drilling of even fairly wide boreholes down to the proposed depths is technology that is known and carried into effect and not forbiddingly expensive.

WO 2006/057603 is a prior art document which discloses a method for the ultimate disposal of nuclear fuel enclosed in sealed storage containers by stacking the storage containers in a deep drilled shaft. The containers are lowered into the shaft to form a single stack having a clearance space to the wall of the shaft. When the stack resting on the bottom of the shaft reaches a height substantially lower than the mouth of the shaft, for example well below the groundwater table at the disposal site the stacking is discontinued. As the stack grows, the clearance space around the containers in the shaft is filled with a suitable setting grouting compound, such as so-called self-compacting concrete, that is, a concrete compound that is substantially more free-flowing that ordinary concrete and can therefore readily form a void-free jacket around the containers. Finally, a backfill material is introduced in the space above the completed stack to seal the shaft.

Setting out from the prior art as disclosed in the above mentioned WO document, the present invention aims at providing an improved method for the ultimate disposal of spent nuclear fuel and other highly radioactive or otherwise extremely dangerous materials in a way that can be expected to meet very strict requirements for the safety of mankind for an extremely long time, even hundreds of thousands of years, and that can be carried into effect at reasonable costs.

Thus, in accordance with the present invention storage containers holding the hazardous material are stacked in shafts drilled deep into the ground, the bedrock, such as two or three thousand metres or more, and in any case down to a depth that can be considered to be adequate, having regard to the geographical position of the repository, the state of the bedrock and other factors relevant to the safety, such as the nature and dangerousness of the hazardous material.

Shafts for the storage containers can be drilled at suitable distances from one another within an area chosen as a site for a repository and in which the bedrock is fairly homogenous. The shafts are slightly wider than the storage containers so that these can easily be brought down to the storage level using suitable handling equipment.

Basically, the detailed design of the storage containers is not essential to the invention, but it goes without saying that the containers should be of a character such that they themselves provide a good protection against all the hazards which the hazardous material exposes the environment to during the handling before and during the deposition in the repository and also a good basic safety in the repository. This means, among other things, that it must be possible to handle the storage containers in a very safe manner and that the storage containers must also be able to stand great unforeseen stresses without compromising the tightness or, when the stored hazardous material is radioactive, the protection against radiation.

Storage container designs offering good prospects of meeting very stringent demands in the just-mentioned respect without being at the same time very demanding in respect of resources or costly, belong to the state of the art. Examples are described in WO2004/051671 and WO2005/064619. These containers form a kind of box-in-box structure in that they have a central, sealed storage space for the hazardous material which is defined by a first, inner layer of a material, suitably metal, and at least one and preferably several surrounding layers of concrete or alternatingly metal and concrete. A damage to a single layer need not, therefore, entail more than, at the very most, a marginal loss of safety.

In accordance with the invention the shaft has a diameter that is slightly larger than the largest external transverse storage container dimension, that is, the diameter in the case of circular cylindrical containers, such as 110-120% of the largest transverse dimension. When the containers have been lowered into the shaft, the space between the containers and the wall of the shaft is grouted with a suitable grouting material, such as concrete, preferably of the self-compacting kind, so that it fills all the cavities around the containers even though it is not vibrated, and suitably also reinforced with fibres. Accordingly, the containers will be surrounded by another protective layer and at the same time anchored to the wall of the shaft. The anchoring can be amplified by providing the outer wall of the containers with a rough or otherwise uneven surface.

Suitably, before the first storage container is lowered into the shaft, a high-strength base plug is placed on the bottom of the shaft and firmly secured by grouting in an accurately oriented position such that it is centred in the shaft with its upper face leveled to form a stable horizontal support surface for the lowermost storage container. A plurality, six or eight, for example, of tension cables are firmly secured to the base plug around its periphery. These tension cables extend upwards to the place from which the lowering of the storage containers is carried out; that place can be at the ground level or alternatively at an underground level.

Then the first storage container is lowered into the shaft suspended from one or more hoisting cables and placed on top of the base plug. The lower end of the storage container may be provided with elements which centre the storage container in the shaft in cooperation with mating elements at the upper end of the base plug. The tension cables, which are distributed around the storage container, guide the storage container laterally during the lowering and may also serve as container centering elements. A succession of additional storage containers are then placed and centred on respectively the first storage container and the next underlying storage container.

Suitably, the stacking of the storage containers in the shaft is effected in groups in the following manner. When a stack formed on top of the base plug reaches a predetermined height and comprises 10 storage containers, for example, the pile formed by these storage containers is grouted, such as with concrete which is suitably of the self-compacting type, so that it fills all open spaces around the storage containers without having to be vibrated, and which is preferably also reinforced with steel fibres.

Before the concrete has hardened, the tension cables may be tensioned so that, after the concrete has hardened for a suitable time, they will subject the group or section formed by the stacked storage containers to a prestress that strengthens the stack of storage containers and the concrete surrounding it.

When the concrete has hardened sufficiently, the group or section of stacked storage containers so formed may be extended in a similar manner by another group or section formed of a number of additional storage containers and grouted with concrete. This group or section can be prestressed in the same way as the first group or section.

Between the stack sections so formed, or between groups of these stack sections, an intermediate plug similar to, but optionally shorter than, the base plug may suitably be introduced and grouted firmly to the wall of the shaft, so that it can eliminate, or at least reduce, transmission of forces from an overlying stack section to underlying stack sections. Such intermediate plugs, which also result in a spreading out of the hazardous material vertically, and thus also an advantageous reduction of the heating of the surrounding rock if the hazardous material generates heat, may also be placed between individual storage containers, although that will be at the cost of a more time-consuming introduction of the storage containers into the shaft.

The shaft should not be completely filled with storage containers, but only up to a certain safe level, so that the topmost storage container will be separated from the top end of the shaft by a safety distance. This safe level or safety distance may depend on the safety requirements in each case, the dangerousness of the hazardous material, the condition of the bedrock, the risk of problems relating to the groundwater and other relevant factors. If the hazardous material is highly radioactive when it is introduced into the shaft, it may be appropriate never to allow the stack of storage containers come closer to the ground level than, for example, 500 or 1000 metres. Preferably, the top of the stack should be below the groundwater table.

That part of the shaft which in the end will be above the uppermost storage container is filled with a suitable material or suitable materials serving to seal the shaft. The sealing material or materials may be chosen such that it will be difficult to remove it, so that sabotage or attempts at recovering material that may be attractive to terrorists will be difficult to carry out.

One or more tubular members (tubes or hoses) may be passed into the shaft together with the base plug and the tension cables. These tubular members may contain, or may later be provided with, suitable communication and/or monitoring equipment, such as equipment for monitoring levels of activity, checking of the centred position of the storage containers, the base plug and the intermediate plugs, movements within the bedrock or within the shaft etc. One or some of the tubular members may initially be left empty in order that it may later be possible to supplement the equipment or to replace equipment that has gone out of order. Moreover, the tubular elements may be used to pass a coolant down into and out of the shaft, such at via passages in the storage containers. The coolant reduces heating of the bedrock around the shaft caused by nuclear fuel that still generates heat. Such reduction of the heat transmission from the storage containers to the surrounding bedrock may be appropriate or necessary if the nuclear fuel is introduced in the shaft a short time after it has been withdrawn from the reactor and the heat generation is therefore still relatively intense.

Because heating or the bedrock around the shaft should be kept down as far as possible within practical and economical limits, it is desirable not to enclose the nuclear fuel in the storage containers immediately after it has been removed from the reactor. During the first year or years after the removal of the nuclear fuel from the reactor the heat production is intense, but it drops to a fraction of the initial one relatively rapidly after the unloading. After a transitional period of a few years it continues to drop but at a much lower rate.

For that reason it is desirable that the nuclear fuel be allowed to cool for a suitable period, 3 to 5 years, for example, after it has been removed from the reactor before it is introduced into the shaft. The cooling may be carried out in the same way as up to the present, that is, by placing the nuclear fuel in a decay pond and keep it there until it is enclosed in storage containers and introduced into the shaft. An alternative that is attractive from a safety point of view is to transfer the nuclear fuel more or less immediately after the removal of it from the reactor to storage containers which are subjected to forced cooling for a period of suitable length, 2 to 5 years, for example, before they are introduced into the shaft. If desired, the storage containers in which the cooling is carried out may be replaced with different storage containers before the introduction into the shaft is carried out. Yet another possibility is to place a cooled storage container holding nuclear fuel in another storage container at the end of the cooling period and introduce that storage container into the shaft.

When storing intensely heat-generating hazardous material, particularly burnt-up and still highly active nuclear fuel, it is generally desirable to distribute the hazardous material vertically and/or laterally in the shaft by placing the hazardous material in shafts which are less wide but larger in number and more spread out and to use more intermediate plugs, instead of placing the hazardous material in wider and fewer shafts and with denser distribution horizontally and vertically. A less dense distribution of the hazardous material reduces the risk of unfavourable influence on the surrounding bedrock.

In a preferred design of storage containers for heat-generating hazardous materials the storage containers are dimensioned and designed to hold a single fuel assembly or a single bundle of fuel rods. Alternatively, the storage containers may hold two or more fuel assemblies or bundles of fuel rods centrally and in axial alignment with one another. Naturally, in that case the storage container will have a considerable height, 9 to 12 metres, for example, if the storage container holds two fuel assemblies or fuel rod bundles, each having a length of 4 metres. An advantage of such an arrangement is that the storage containers, and therefore also the shafts, can have a relatively short diameter, such as, for example, 50 to 70 cm for the storage containers and 60 to 90 cm for the shafts.

In another feasible design, each storage container may hold a group of four fuel assemblies or bundles of fuel rods placed side by side. Of course, in this case the diameter or transverse dimension of the storage containers and, consequently, the diameter of the shaft as well, will have to be, for example, some 20 centimetres larger than the corresponding dimensions for a single fuel assembly. A further disadvantage is that the heat load on the storage container and the bedrock from the nuclear fuel will be correspondingly higher. For that reason, this design is primarily suitable in cases in which the heat production of the nuclear fuel has fallen to a low level.

Appropriately, the fuel assemblies or fuel rod bundles are grouted with concrete in connection with their placement in the storage container so that the spaces between the fuel rods in the fuel assemblies or fuel bundles will also be filled with concrete, preferably self-compacting fibre reinforced concrete.

Using the deep drilling technology existing today, the shafts can be drilled in a rational and economical way. The shafts may be drilled successively at a pace corresponding to the need for storage space, or they may all be drilled at the same time in a number corresponding to the calculated requirement for storage space for one or more decades, for example, and filled successively as required.

The shafts are drilled at distances from one another which are adapted to a calculated total demand for storage space and the accessible usable ground space at the repository site, the diameter of the shafts and other relevant factors, such as the heat load that the stored material will likely apply to the bedrock around each shaft for the period of time in which the nuclear fuel will generate heat to a substantial extent.

The invention will be additionally described below with reference to the accompanying diagrammatic drawings, taking just nuclear fuel, and more particularly nuclear fuel rods in a nuclear fuel assembly, as an example of the material which is to be stored in a repository for the ultimate disposal in accordance with the invention. However, the method for the ultimate disposal in accordance with the invention is not limited to such material, but can also be used for other hazardous materials requiring an extremely high degree of safety. Accordingly, the invention is not limited to nuclear fuel and may be applied to hazardous materials in a broad sense.

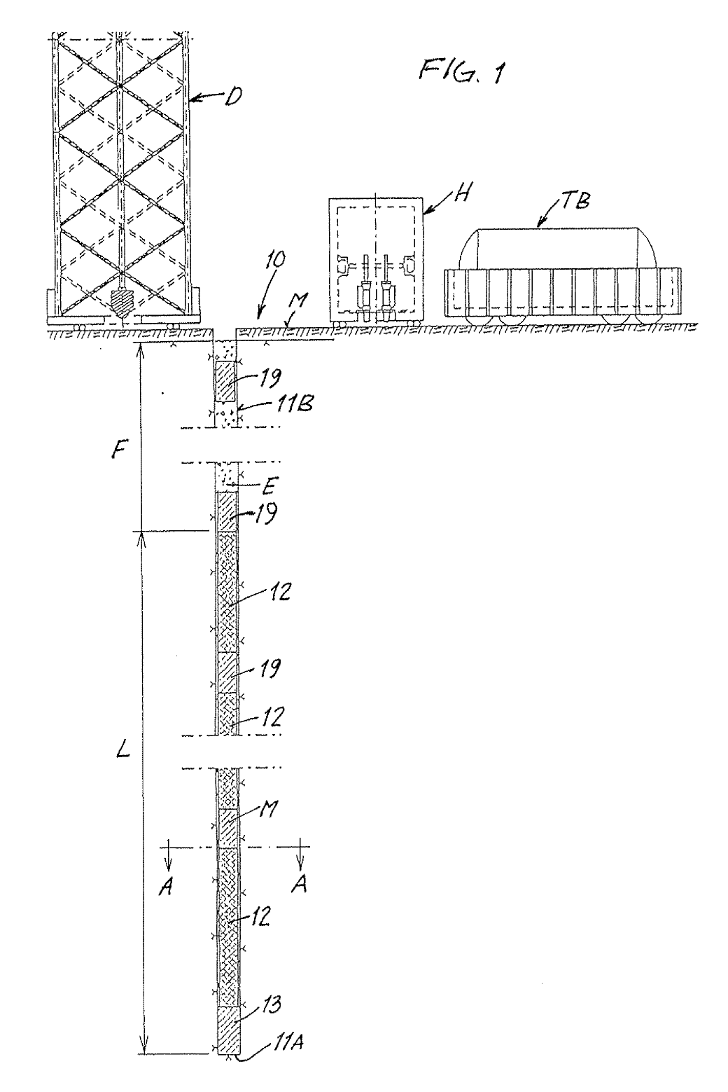

FIG. 1 is a diagrammatic illustration of a completed repository for the ultimate storage of nuclear fuel, comprising a single shaft and also shows, likewise diagrammatically, machinery equipment used for drilling the shaft and filling and sealing of the shaft;

FIG. 2 is a vertical sectional view drawn to a larger scale of a section of the shaft holding a storage container in which a nuclear fuel assembly is enclosed, and also an intermediate plug on which the storage container rests;

FIG. 3 is a vertical sectional view of the shaft adjacent to the bottom of the shaft and shows the upper portion of the base plug with tension cables attached to it and also the lower portion of the storage container first inserted;

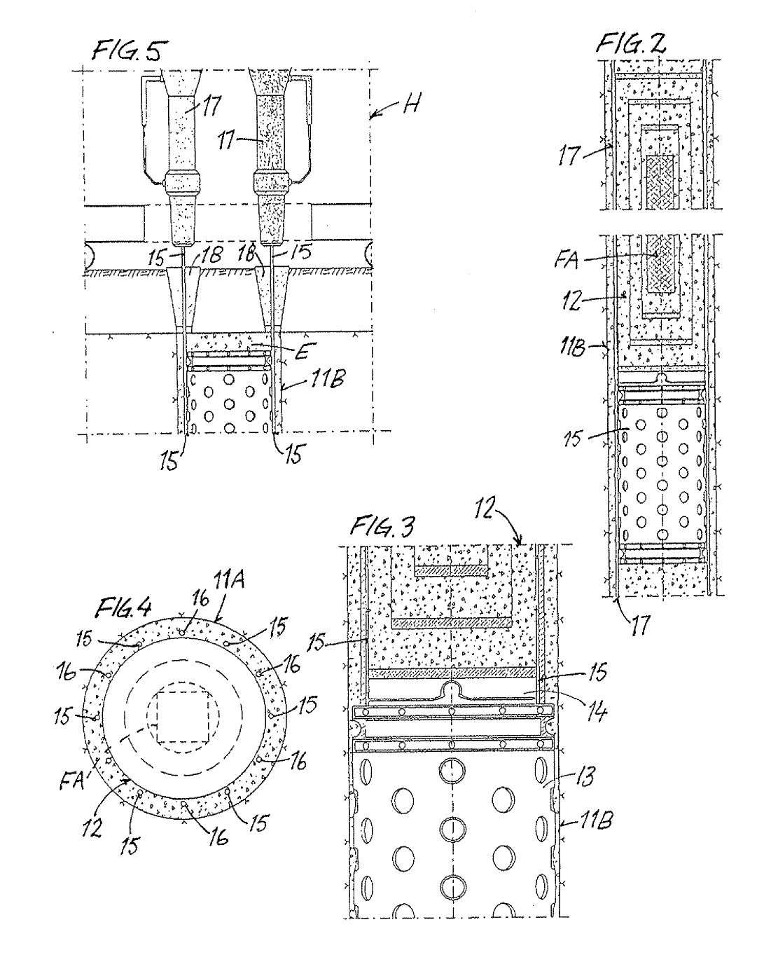

FIG. 4 is a horizontal sectional view, taken along line A-A in FIG. 1, of the shaft and a storage container; and

FIG. 5 is a vertical sectional view of a device for lowering the storage containers into the shaft and for tensioning and clamping the tension cables.

The section of the completed repository 10 shown in FIG. 1 comprises, in addition to the drilled shaft 11, both a section designated L and forming the section of the shaft 11 that holds the stored storage containers 12, each such storage container holding a nuclear fuel assembly with fuel rods, and a section designated F which is disposed directly above the section L and filled with a material E to form a seal of the repository 10. As shown, section F extends to the ground level M or to a level near the ground level. Alternatively, it can extend to the floor of a space that is partially or completely located underground, such as in a rock chamber. This section F represents a safety distance that separates the stored nuclear fuel in the storage containers 12 from the ground level M.

The safety distance may be determined in dependence on various factors which are relevant to the safety requirement that applies to the repository and also in dependence on rules or norms laid down by a national or international authority, the groundwater level, the kind of hazardous material to be stored, etc. In the repository 10 shown only by way of example the safety distance is at least 500 metres, and the depth of the shaft is 1500 metres, but it is to be understood that the safety distance and the depth of the shaft may have other values within the scope of the invention. For that reason, the values given here are only to be taken as guiding.

The shaft may be drilled in any suitable way using known and well-tried deep drilling technology. In the case shown by way of example, in which the part of the shaft cross-section that accommodates the nuclear fuel is dimensioned for a single fuel assembly, designated FA in FIGS. 2 and 4, the shaft diameter may be, for example, 60 to 80 cm and about 10 cm shorter than the diameter of the circular cylindrical storage containers 12. Naturally, if the nuclear fuel subtends a substantially greater cross-section in the storage containers 12, the shaft diameters may be larger and vary over a greater range.

In the illustrated example the storage containers 12 are designed in accordance with the patent publications mentioned above, but storage containers of different designs may be used. They may be produced and loaded with the fuel assemblies FA at or near the repository site, the fuel assemblies being transported there in any suitable manner from a decay pond. In FIG. 1, a vehicle TB represents equipment for the trans-port of the fuel assemblies FA, the production and loading of the storage containers 12 and the transfer of the loaded storage containers to the hoisting and tensioning apparatus H.

Resting on the bottom 11A of the shaft 11 is a base plug 13 which serves both as a base or pedestal for storage containers 12 lowered into the shaft and as an anchor for the tension cables and the tubular members which are mentioned above in this description and will be described in more detail below. Advantageously, the base plug 13 can also contain auxiliary equipment, such as for monitoring and control of the lowering of the base plug, and later also for monitoring of the repository in respect of various parameters (temperature, leakage, radiation, seismic movements etc.) and for communication with a control centre located at the ground level or in some other suitable place. The base plug 13 is essentially a steel cylinder having a circular base plate of steel and a likewise circular top plate of steel provided with a centering member 14 for the overlying storage container 12 and, moreover, filled with fibre reinforced concrete.

The circumferential surface of the base plug 13 is provided with roughness formations and thus is not smooth. In the figures of the drawings these roughness formations are exemplified by depressions in the circumferential surface, but they can take any suitable shape. After the grouting of the base plug 13 they contribute to the anchoring of the base plug to the shaft wall 11A, which in itself is rough as a result of the drilling.

A number of tension cables 15 are attached around the peripheral part of the base plug 13. In the illustrated example there are six such tension cables 15 which are evenly distributed over the periphery. Provided between and alternating with the tension cables 15 are six tubular members 16, suitably formed by tubes or age-resisting hoses, some of which may hold conductors and other means for the communication mentioned above in this description. One or a few of the tubular members 16 may be empty and reserved for use as required, such as in the event of a failure in one of the other tubular members.

When the shaft 11 has been drilled down to the predetermined depth by means of the drilling equipment D, that equipment is moved away from the shaft to leave room for the hoisting and tensioning apparatus H, which is used first to lower the base plug 13 and the tension cables 15 and tubular members 16 attached to it to the bottom 11A of the shaft 11 and then to lower the storage containers 12 and also to convey a concrete grouting compound or some other suitable grouting material into the shaft and tighten the tension cables 15.

Initially, the base plug 13 is lowered to the bottom 11A of the shaft 11, where the base plug is centred in the shaft so that it will be as accurately coaxial with the shaft as possible. Concrete grouting compound is injected around the base plug and allowed to harden for a prescribed time to fix the base plug 13 in the coaxial position in the shaft.

The first storage container 12 is then lowered to the base plug 13 so that it will rest on it in a centred position. During the lowering, the storage container can be guided by the tension cables 15 which are held well tightened. It is also possible to guide the storage container 12 during the lowering by means of sliding members which are mounted on the storage container and coact with the shaft wall 11A (the base plug 13 may also be guided in a similar manner as it is being lowered).

The lowered storage container 12, which is roughened for the same reason as the base plug 13, is fixed in position by injection of concrete grouting compound around it, and then additional storage containers 12 are lowered and fixed in the same way.

In this way a section of a stack is built in the shaft 11 from a group of, for example, five or ten storage containers 12. These storage containers may advantageously be grouted simultaneously, rather than one by one. If desired, the number of storage containers in the stack section may be varied in accordance with detected local conditions in the bedrock.

Before the concrete grouting compound has set, the tension cables 15 are tensioned by means of jacks 17 in the hoisting and tensioning apparatus 17 and then locked in the tensioned state by means of arresting members 18 represented by arresting wedges in FIG. 6. When the concrete grouting compound has hardened for a prescribed time, the tension cables 15 are relieved to apply a prestress to the concrete.

On top of the stack section or, if desired, on top of the topmost stack section, or on top of one or several additional stack sections made in the same way as the first one, an intermediate plug 19, similar to the base plug 13 but smaller in diameter, suitably of the same diameter as the storage containers, is placed. The intermediate plug 19 is fixed to the shaft wall 11B by injection of concrete grouting compound around it.

The building of the stack of storage containers 13 is continued in the described manner until the storage container holding section L of the shaft 11 is filled. Then the shaft is sealed in the F section, suitably by a backfill of, for example, columns of self-compacting concrete which are separated by intermediate plugs 19, if desired with such a plug as a termination, until the ground level has been reached. Other backfill elements or materials may of course also be used.

The ultimate storage may by extended by additional shafts 11 which are drilled and filled with additional storage containers 12 in the manner described above and then sealed. The horizontal distances separating the shafts are chosen such that the heating effect on the surrounding bedrock resulting from heat generated by the stored nuclear fuel in individual shafts will not extend to adjacent shafts.

When the repository 10 is filled to its capacity or need no longer be extended, the ground at the site of the repository may be restored or rearranged in a suitable manner having regard to esthetical and other requirements or wishes. Supervision and inspection may also be organized in accordance with regulations or wishes.

As is readily appreciated, the method according to the invention as described above can be varied in many ways within the scope of protection as determined by the claims. For example, it may be possible and desirable, having regard to the circumstances, such as the size and the weight of the storage containers and the capacity of the equipment to lower a plurality of pre-stacked storage containers at the same time. Within the scope of the claims it is also possible to make the storage containers high enough for each storage container to be able to accommodate two nuclear fuel assemblies or similar units of nuclear fuel aligned one above the other and separated from one another by a suitable axial space, so that the filling of the shaft can be carried out more rapidly. Moreover, the intermediate plugs can be interconnected with the overlying or underlying storage container before the lowering into the shaft is carried out.

1. A method for the underground ultimate disposal of hazardous material, particularly radioactive hazardous waste, such as nuclear fuel, comprising the steps of
enclosing the hazardous material in substantially identical storage containers,
drilling a shaft which is wide enough to accommodate a single stack of the storage containers with a clearance space to the wall of the shaft and deep enough to receive both the stack of the storage containers and a backfill above the stack for sealing the shaft,
attaching a plurality of cables to a base plug at anchoring points distributed around the base plug, the plug being dimensioned such that it can be accommodated in the shaft with a clearance space to the wall of the shaft, and the cables being long enough to extend from the mouth of the shaft to the bottom of the shaft,
lowering the base plug to the bottom of the shaft with the cables attached to it, positioning the base plug in a centred position at the bottom of the shaft and anchoring it to the shaft wall in the centred position by introducing a setting grouting compound between the shaft wall and the base plug and allowing the grouting compound to set,
lowering the storage containers into the shaft, at least one at a time, forming the storage containers into a stack resting on the base plug and holding the cables tensioned during the lowering of the storage containers to counteract lateral movements of the plugs at least when the storage containers approach the base plug,
introducing a setting grouting compound around the lowered storage containers and allowing the grouting compound to set, and
after the lowering of the storage containers is completed, introducing a backfill into the shaft to seal the shaft.

2. A method according to claim 1, in which after a first group of the storage containers have been lowered into the shaft and formed to a first stack section above the base plug, the setting grouting compound is introduced into the clearance space between the wall of the shaft and the group of storage containers, whereupon the cables are tensioned, the setting grouting compound is allowed to set, and the tensioned cables are then relieved to pre-stress the grouting compound.

3. A method according to claim 2, in which
after the first group of storage containers have been introduced into the shaft and the grouting compound around that group has set completely, a second group of storage containers are introduced into the shaft and formed to second stack section above the first stack section, the grouting compound is introduced into the clearance space between the wall of the shaft and the second stack section and allowed to set, and
the cables are then again tensioned and, after the grouting compound has set, relieved to pre-stress the grouting compound around the second additional group of storage containers.

4. A method according to claim 3, in which an intermediate plug is anchored to the shaft wall for each section of storage containers or for selected sections of storage containers.

5. A method according to claim 1, in which self-compacting concrete is used as the setting grouting compound.

6. A method according to claim 1, in which in addition to the cables at least one tubular member, such as at least one hose and/or at least one tube, is anchored in the base plug to form one or more communication or monitoring channels extending to the upper end of the shaft.
